(19) United States
(12) Patent Application Publication
(10) Pub. No.: US 2018/0082086 A1
(43) Pub. Date: Mar. 22, 2018

(54) VEHICLE INTERNET SYSTEM AND METHOD

(71) Applicants: Elphinstone Birch, Santa Clara, CA (US); Hannah Birch, Santa Clara, CA (US)

(72) Inventors: Elphinstone Birch, Santa Clara, CA (US); Hannah Birch, Santa Clara, CA (US)

(21) Appl. No.: 15/598,020

(22) Filed: May 17, 2017

Related U.S. Application Data
(60) Provisional application No. 62/398,249, filed on Sep. 22, 2016.

(51) Int. Cl. G06F 21/88; H04L 29/08; H04L 12/24; G06F 3/14; G06F 21/84; B60R 11/02; B60R 16/03; B60R 16/037; H02J 7/00

(52) U.S. Cl. CPC G06F 21/88; H04L 67/12; H04L 41/0803; G06F 3/1423; G06F 21/84; H04W 84/005; B60R 16/03; B60R 16/037; H02J 7/0045; H02J 7/0052; B60R 11/0252

(57) ABSTRACT

A vehicle internet system includes a portable monitor for viewing internet-based content having touchscreen display, a processor, a power supply, an operating system, and a wireless internet apparatus. The portable monitor is configured to be removably retained in a vehicle mounting assembly installed on the dashboard or on the backside of the vehicle's headrests. The system also includes an external mobile communications terminal configured to send and receive data transmissions to and from a vehicle, which are in turn fed to the portable monitors within the vehicle. The portable monitor also has an embedded security protocol including password protection feature that is useful for deactivating the portable monitors if they are removed from the vehicle without permission.

### CROSS-REFERENCE TO RELATED APPLICATION(S)

The present application is related to and claims priority to U.S. Provisional Patent Application No. 62/398,249 filed Sep. 22, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of electrical computers of existing art and more specifically relates to wireless internet devices.

### RELATED ART

A mobile device (or handheld computer) is a computing device small enough to hold and operate in the hand. Typically, the device has either a flat screen display with a small numeric keypad or alphanumeric keyboard, or a touchscreen providing a virtual keyboard and buttons (icons) on-screen. Many such devices can connect to the Internet and interconnect with other devices such as entertainment systems or headsets via Wi-Fi, Bluetooth or near field communication (NFC).

Riding in a vehicle for extended periods of time can be boring, especially for children who have now become accustomed to using their mobile devices wherever they go. Without television programs, videos, or movies to view, children may become extremely frustrated, stressed, and rambunctious. Further, workers without access to wireless internet while driving may miss important conference calls, e-faxes, emails, and other online items. A suitable solution is desired.

U.S. Pub. No. 2013/0055096 to Kim et al., relates to a mobile terminal, image display apparatus mounted in vehicle and data processing method using the same. The described mobile terminal, image display apparatus mounted in vehicle and data processing method using the same includes an image display apparatus mounted in a vehicle, which includes a communication unit for transmitting/receiving data to/from an external mobile terminal, and a controller for generating Internet access information including Internet access environment information about the image display apparatus and controlling the communication unit to transmit the generated Internet access information to the mobile terminal, wherein the Internet access information includes at least one of Internet access state information representing whether the image display apparatus is connected to the Internet, and roaming state information representing whether a roaming service is used for Internet access of the image display apparatus. According to a mobile terminal, image display apparatus mounted in a vehicle and data processing method using the same, Internet access information can be efficiently transmitted between the mobile terminal and the image display apparatus.

### SUMMARY OF THE INVENTION

In view of the foregoing disadvantages inherent in the known electrical computer art, the present disclosure provides a novel device for browsing the internet while in a vehicle. The general purpose of the present disclosure, which will be described subsequently in greater detail, is to provide a vehicle internet system and method.

A vehicle internet system is disclosed herein. The vehicle internet system may include a portable monitor configured to display internet-based content having a housing, a display, a processor, a power supply, an operating system, and a wireless internet apparatus. The vehicle internet system may further include an external mobile communications terminal configured to send and receive data transmissions to and from a vehicle. In a preferred embodiment, the vehicle internet system may feature a vehicle mounting assembly configured to removably retain the portable monitor and an embedded security protocol that may be programmed to disable the portable monitor if removed from the vehicle without authorization.

According to another embodiment, a method of use for the vehicle internet system is also disclosed herein. The method of use for the vehicle internet system may include turning on the vehicle, removing the portable monitor, using the portable monitor to access the internet, and replacing said portable monitor.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vehicle internet system, constructed and operative according to the teachings of the present disclosure.

FIG. 1 is a perspective view of the vehicle internet system during an ‘in-use’ condition, according to an embodiment of the disclosure.

FIG. 2 is another perspective view of the vehicle internet system of FIG. 1, according to an embodiment of the present disclosure.

FIG. 3 is an additional perspective view of the vehicle internet system of FIG. 1, according to an embodiment of the present disclosure.

FIG. 4 is another front view of the vehicle internet system of FIG. 1, according to an embodiment of the present disclosure.

FIG. 5 is a flow diagram illustrating a method of use for the vehicle internet system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to electrical computers and more particularly to a vehicle internet system as used to improve internet accessibility for occupants of a vehicle.

Generally, Wi-Fi is a technology that allows electronic devices to connect to a wireless LAN (WLAN) network, mainly using the 2.4 gigahertz UHF and 5 gigahertz SHF ISM radio bands. A WLAN is usually password protected, but may be open, which allows any device within its range to access the resources of the WLAN network.

The present system provides vehicles with a wireless internet system and monitors capable of streaming and displaying videos, movies, conference calls, online browsing, and much more. This includes monitors integrated into the dashboard and the rear portion of both the driver and passenger headrests. It features touchscreen capabilities on each monitor for ease of access, allowing children to select their own video programs and movies during a long car trip. It utilizes built-in security coding that renders the monitors useless should they be removed from the vehicle without authorization. The present invention eliminates the worry of businessmen and women missing important meetings, calls, e-faxes, emails, and the like. In addition to providing entertainment and business support, the vehicle internet system of the present disclosure may be further useful for increased safety measures including wildfire assistance, police avoidance, and removing the hassles of holding a mobile phone while traveling in a vehicle.

The system of this disclosure may also be referred to as “El Monitor.” El Monitor comprises very unique characteristics and functionalities that set it aside from the rest of its competitors. The El Monitor system may have the ability to: 1) access the internet from a built-in computer on a vehicle; 2) be touch screen compatible, thus allowing convenient interaction with the computer system; 3) provide effective and efficient solutions for recreational and business needs; 4) be installed in the dashboard and on the back of the front head-rests, with further ability to detach from the head-rests for convenient and portable usage; 5) provide coded security that will render it useless if stolen from within a vehicle; 6) adjust the screen vision to help those with vision problems, such as adjusting images far and near and enlarging images on the screen; 7) receive a portable display into the dashboard whenever the vehicle is being shut-off and comes out of the dashboard when the vehicle starts or its ignition turned to the switch on position.

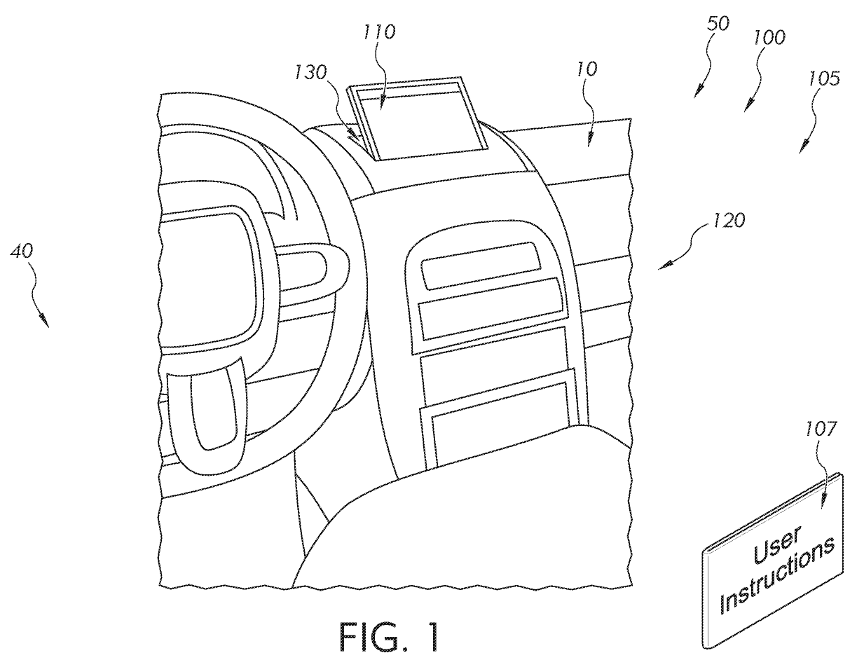

Referring now more specifically to the drawings by numerals of reference, there is shown in FIGS. 1-4, various views of a vehicle internet system 100. FIG. 1 shows a vehicle internet system 100 during an ‘in-use’ condition 50, according to an embodiment of the present disclosure. Here, the vehicle internet system 100 may be beneficial for use by a user 40 to access the internet while in a vehicle. As illustrated, the vehicle internet system 100 may include a portable monitor 110 that is configured to be removably retained within a vehicle mounting assembly 130 provided in a vehicle 10. The vehicle internet system 100 may further include an external mobile communications terminal 120 configured to send and receive data transmissions to and from a vehicle 10.

According to one embodiment, the vehicle internet system 100 may be arranged as a kit 105. In particular, the vehicle internet system 100 may further include a set of instructions 107. The instructions 107 may detail functional relationships in relation to the structure of the vehicle internet system 100 such that the vehicle internet system 100 can be used, maintained, or the like, in a preferred manner.

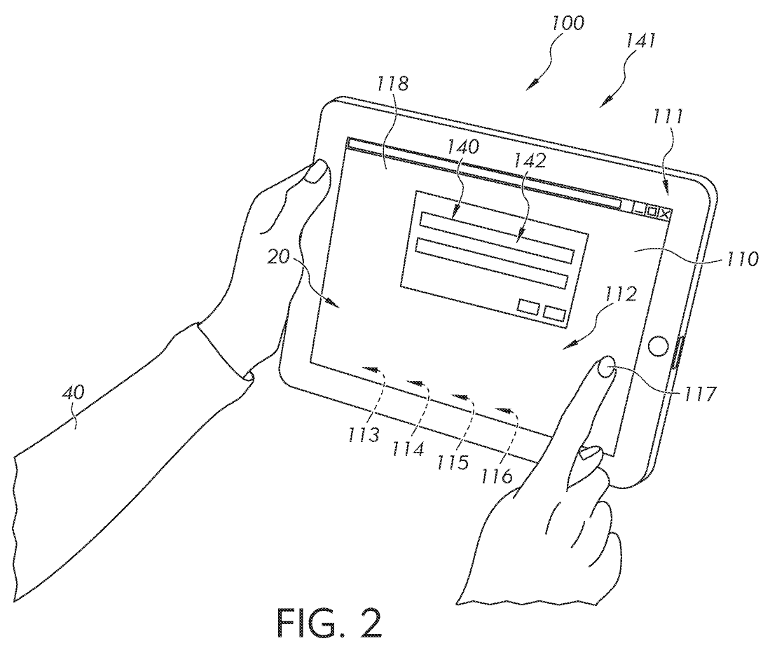

FIG. 2 shows the vehicle internet system 100 of FIG. 1, according to an embodiment of the present disclosure. As above, the vehicle internet system 100 may include a portable monitor 110 having a housing 111, a display 112, a processor 113, a power supply 114, an operating system 115, and a wireless internet apparatus 116. The included display 112 may be useful for viewing internet-based content 20 and may itself feature touchscreen control functions 117 and an image resolution 118 that may be selectably adjustable by a user 40. In this embodiment, the portable monitor 110 may additionally include an embedded security protocol 140 including a password protection feature 142 that is configured to disable the portable monitor 110 upon detecting an unauthorized removal condition 141.

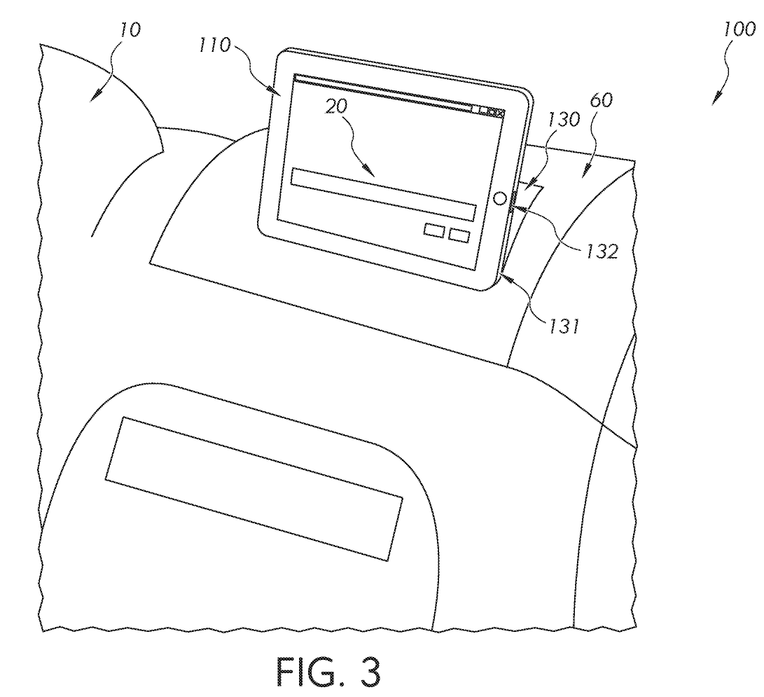

Referring now to FIG. 3, a perspective view of the vehicle internet system 100 of FIG. 1, according to an embodiment of the present disclosure. As in FIG. 1, the vehicle internet system 100 may include a portable monitor 110 configured to display internet-based content 20. The portable monitor 110 may be configured to be removably retained within a vehicle mounting assembly 130 that is mounted into the dashboard 60 of a vehicle 10. The vehicle mounting assembly 130 may include a charging assembly 131 having frictional contact points 132 for delivering an electrical charge to the portable monitor 110.

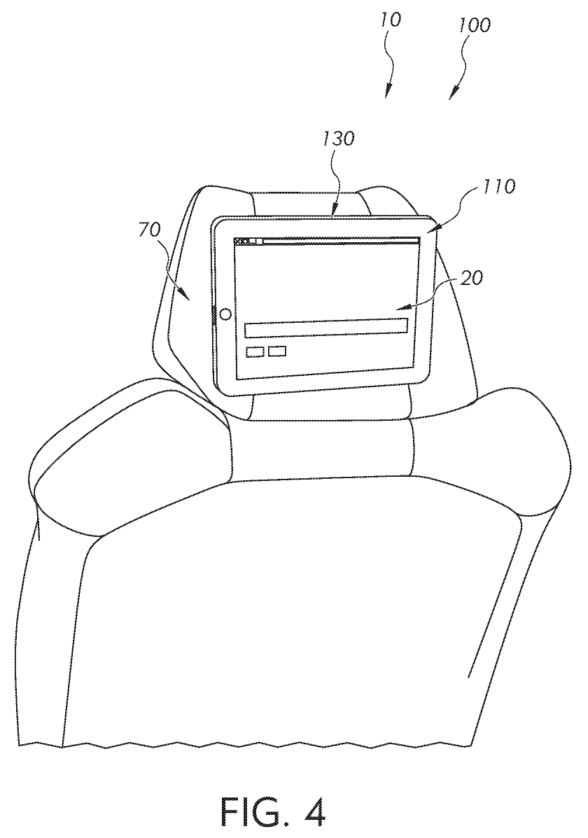

FIG. 4 is a front view of the vehicle internet system 100 of FIG. 1, according to an embodiment of the present disclosure. In this embodiment, the portable monitor 110 of the vehicle internet system 100 may be mounted into the backside of a headrest 70 of a vehicle 10. The portable monitor 110 allows internet-based content 20 to be displayed while residing in a vehicle mounting assembly 130 that is mounted into the headrest 70.

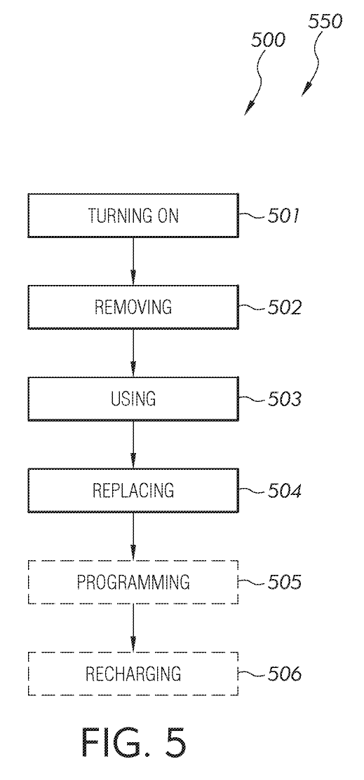

FIG. 5 is a flow diagram 550 illustrating a method of use 500 for the vehicle internet system 100, according to an embodiment of the present disclosure. In particular, the method for method of use 500 may include one or more components or features of the vehicle internet system 100 as described above. As illustrated, the method of use 500 may include the steps of: step one 501, turning on the vehicle; step two 502, removing the portable monitor; step three 503, using the portable monitor to access the internet; step four 504, replacing the portable monitor.

It should be noted that step five 505, programming a password protection feature, and step six 506, recharging the portable monitor, are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the vehicle internet system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle internet system, the system comprising:
a portable monitor having a housing, a display, a processor, a power supply, an operating system, and a wireless internet apparatus;
an external mobile communications terminal configured to send and receive data transmissions to and from a vehicle;
a vehicle mounting assembly; and
an embedded security protocol;
wherein said portable monitor is configured to display internet-based content;
wherein said portable monitor is configured to be removably retained within said vehicle mounting assembly; and
wherein said embedded security protocol is configured to disable said portable monitor upon detecting an unauthorized removal condition of said portable monitor from said vehicle.

2. The vehicle internet system of claim 1, wherein said display features touchscreen control functions.

3. The vehicle internet system of claim 1, wherein said wireless internet apparatus is configured to send and receive data to and from said external mobile communications terminal.

4. The vehicle internet system of claim 3, wherein said external mobile communications terminal is based in said vehicle.

5. The vehicle internet system of claim 1, wherein said vehicle mounting assembly is configured for installation in a dashboard of said vehicle.

6. The vehicle internet system of claim 1, wherein said vehicle mounting assembly is configured for installation on the backside of a headrest in said vehicle.

7. The vehicle internet system of claim 1, wherein an image resolution of said display is selectably adjustable.

8. The vehicle internet system of claim 1, wherein said embedded security protocol includes a password protection feature.

9. The vehicle internet system of claim 8, wherein said embedded security protocol triggers a shutdown of said portable monitor if said password protection feature is violated.

10. The vehicle internet system of claim 1, wherein said unauthorized removal condition is triggered when said portable monitor moves more than 10 feet away from said vehicle.

11. The vehicle internet system of claim 1, wherein said vehicle mounting assembly further includes a dashboard removal trigger mechanism that allows said portable monitor to be placed in said vehicle mounting assembly installed in said dashboard whenever said vehicle is being shut off.

12. The vehicle internet system of claim 11, wherein said dashboard removal trigger mechanism allows said portable monitor to be removed from said vehicle mounting assembly installed in said dashboard whenever said vehicle is being turned on.

13. The vehicle internet system of claim 1, wherein said external mobile communications terminal is capable of simultaneously communicating with a plurality of said portable monitors in said vehicle.

14. The vehicle internet system of claim 1, wherein said power supply of said portable monitor is rechargeable.

15. The vehicle internet system of claim 1, wherein said vehicle mounting assembly further includes a charging assembly.

16. The vehicle internet system of claim 15, wherein said charging assembly features frictional contact points for delivering an electrical charge to said power supply of said portable monitor.

17. A vehicle internet system, the system comprising:
a portable monitor having a housing, a display, a processor, a power supply, an operating system, and a wireless internet apparatus;
an external mobile communications terminal configured to send and receive data transmissions to and from a vehicle;
a vehicle mounting assembly; and
an embedded security protocol;
wherein said portable monitor is configured to display internet-based content;
wherein said portable monitor is configured to be removably retained within said vehicle mounting assembly;
wherein said embedded security protocol is configured to disable said portable monitor upon detecting an unauthorized removal condition of said portable monitor from said vehicle;
wherein said display features touchscreen control functions;
wherein said wireless internet apparatus is configured to send and receive data to and from said external mobile communications terminal;
wherein said external mobile communications terminal is based in said vehicle;
wherein said vehicle mounting assembly is configured for installation in a dashboard of said vehicle;
wherein said vehicle mounting assembly is configured for installation on the backside of a headrest in said vehicle;
wherein an image resolution of said display is selectably adjustable;
wherein said embedded security protocol includes a password protection feature;
wherein said embedded security protocol triggers a shutdown of said portable monitor if said password protection feature is violated;
wherein said unauthorized removal condition is triggered when said portable monitor moves more than 10 feet away from said vehicle;
wherein said vehicle mounting assembly further includes a dashboard removal trigger mechanism that allows said portable monitor to be placed in said vehicle mounting assembly installed in said dashboard whenever said vehicle is being shut off;
wherein said dashboard removal trigger mechanism allows said portable monitor to be removed from said vehicle mounting assembly installed in said dashboard whenever said vehicle is being turned on;
wherein said external mobile communications terminal is capable of simultaneously communicating with a plurality of said portable monitors in said vehicle;
wherein said power supply of said portable monitor is rechargeable;
wherein said vehicle mounting assembly further includes a charging assembly; and
wherein said charging assembly features frictional contact points for delivering an electrical charge to said power supply of said portable monitor.

18. The vehicle internet system of claim 17, further comprising set of instructions; and
wherein the system is arranged as a kit.

19. A method of use for the vehicle internet system, the method comprising the steps of:
turning on a vehicle;
removing a portable monitor;
using said portable monitor to access internet; and
replacing said portable monitor.

20. The method of claim 19, further comprising the steps of:
programming a password protection feature; and
recharging the portable monitor.
